(19) United States
(12) Patent Application Publication
(10) Pub. No.: US 2014/0177622 A1
(43) Pub. Date: Jun. 26, 2014

(54) CELL DETECTION

(71) Applicant: BROADCOM CORPORATION, Irvine, CA (US)

(72) Inventors: Carsten JUNCKER, Herlev (DK); Harri Aatos JOKINEN, Pertteli (FI)

(73) Assignee: BROADCOM CORPORATION, Irvine, CA (US)

(21) Appl. No.: 14/132,037

(22) Filed: Dec. 18, 2013

(30) Foreign Application Priority Data
Dec. 21, 2012 (GB) 1223288.0

(51) Int. Cl. H04W 56/00; H04L 12/26

(52) U.S. Cl. CPC H04W 56/004; H04L 43/067
USPC 370/350

(57) ABSTRACT

Apparatus, a method and a non-transitory computer-readable storage medium including a set of computer-readable instructions stored thereon, which when executed by a processor causes performance of operations, including periodically measure a received signal strength indication of a broadcast control channel received from a current serving cell to detect a presence of a co-channel broadcast control channel interference. In response to determining the presence of the co-channel broadcast control channel interference, a synchronization channel re-read based upon one or more co-channel interference criteria is initiated. The synchronization channel re-read is adapted to determine if one or more neighbouring cells that are broadcasting on the same frequency as the broadcast control channel frequency of the current serving cell would be better than the current serving cell.

### CROSS REFERENCE TO RELATED APPLICATION

This application claims the benefit under 35 U.S.C. §119(a) and 37 CFR §1.55 to UK Patent Application No. 1223288.0, filed on Dec. 21, 2012, the entire content of which is incorporated herein by reference.

### FIELD OF THE INVENTION

The present invention relates to apparatus, a method and a non-transitory computer readable medium for cell detection. The example and non-limiting embodiments of this invention relate generally to wireless communication systems, methods, devices and non-transitory computer readable media, and, more specifically, relate to determining if a wireless communication device is coupled to the best cell among a plurality of cells in the wireless communication systems.

### BACKGROUND INFORMATION

Frequency reuse in wireless communication systems is becoming more common among co-located access points to enhance the transmission capacity of wireless communication devices populating those systems. In Global System for Mobile Communications (GSM) networks, more enhanced mobile stations (or user equipment with GSM capabilities) are now populating the networks. That is, enhanced GSM mobile stations (MS) (or user equipment (UE) with enhanced GSM receivers) may now optionally include several mutually exclusive enhanced performance receivers as a result of the Third Generation Partnership Project (3GPP) adoption of several release-independent features.

For example, one enhanced receiver performance feature is so-called “TIGHTER” which provides for tightened link level performance requirements for single antenna mobile stations. TIGHTER was specified for 3GPP Release 10 as a release independent feature and is a technical enhancement to GSM receivers which “tightens” the majority of all downlink (DL) single antenna receiver performance requirements for all GSM data and voice services by at least 2 dB through the application of more sophisticated processing techniques. TIGHTER was specified irrespectively of the applied modulation type, and applies for both the 3GPP reference sensitivity and reference interference performance requirements. Previously and in contradiction to TIGHTER, Downlink Advance Receiver Performance (DARP) Phase I was introduced in Release 6 as a release-independent feature to improve the reception performance of the GSM receiver when receiving a voice or data service transmitted using Gaussian minimum shift keying (GMSK) modulation and only when operating in an interference limited environment through the use of Single Antenna Interference Cancellation (SAIC). Subsequently and in contradiction to DARP Phase I and TIGHTER in 3GP Release 7, DARP Phase II (also known as GSM Mobile Station Receiver Diversity (MSRD)) was introduced as another independent feature that improved the reception of a transmitted signal by using two antennas to enable diversity techniques between the two received signals.

Such new enhanced GSM receivers (e.g. DARP Phase 1, DARP Phase 2 and TIGHTER or the like) are increasingly being employed in networks using a tight frequency reuse factor to increase transmission capacity. That is, as mentioned above, DARP Phase 1, DARP Phase 2 and TIGHTER are release-independent, and as such the 3GPP specification only specifies conformance requirements (e.g. minimum performance requirements). Therefore, each MS receiver performance enhancement technique (as well as the enhancement technique utilization) typically differs from MS to MS. One reason for this lack of uniformity among mobile stations is due to various vendors picking and choosing different release-independent features (DARP Phase 1, DARP Phase 2 or TIGHTER) to implement in their mobile stations or user equipment, thus causing a large spread among the MS performance margins towards the 3GPP specified minimum performance requirements, the vendors' motivations being a result of their efforts to compete to offer the best performing MS for the respective customers.

In deployment scenarios where significant frequency reuse is employed, DARP Phase I compliant, DARP Phase II compliant and TIGHTER compliant MSs (or UEs with GSM enhanced receivers) camped on a serving cell are typically unable to determine if another neighbour cell broadcasting on the same control channel (same frequency) appears to be better (in terms of signal level which in practice also means in terms of signal quality).

Accordingly, there is a need for apparatus, methods, and computer programs that permit enhanced GSM receivers camped on a serving cell to determine if another neighbour cell broadcasting on the same control channel (same frequency) appears to be better.

The following abbreviations which may be found in the specification and/or the drawing figures are defined as follows:
2G Second Generation
3G Third Generation Partnership Project
ACI adjacent channel interference
BA BCCH allocation
BCCH broadcast control channel
BSIC base station identity code
BTS base transceiver station
BCC BTS colour code
C1 path loss criterion value
C2 cell reselection criterion value
CCI co-channel interference
CIR carrier to interference ratio
CS circuit switched
DARP downlink advance receiver performance
DL downlink
DTM dual transfer mode
DTX discontinuous transmission
EDGE Enhanced Data Rates for GSM Evolution
EGPRS2 Enhanced General Packet Radio Service Phase 2
EUTRAN Evolved Universal Terrestrial Radio Access Network
FB frequency burst
FN frame number
GERAN GSM/EDGE Radio Access Network
GSM Global System for Mobile Communications
GMSK Gaussian minimum shift keying
GPRS General Packet Radio Service
ISI inter-symbol interference
LTE Long Term Evolution
LTE-A Long Term Evolution Advanced
MS mobile station
MSRD mobile station receiver diversity
NC1 Network_Control_Order 1
NC2 Network_Control_Order 2
NCC network colour code
PS packet switched
PSW pure sine wave
QAM quadrature amplitude modulation.
RF radio frequency
RSSI received signal strength indicator
SAIC single antenna interference cancellation
SCH synchronization channel
SI system information
TDMA time division multiple access
TIGHTER tightened link level performance requirements for single antenna MS
TS transmission slot
UE user equipment
UL uplink
UTRAN Universal Terrestrial Radio Access Network

### SUMMARY

According to a first aspect of the present invention, there is provided a method including periodically measuring a received signal strength indication of a broadcast control channel received from a current serving cell to detect a presence of a co-channel broadcast control channel interference; and in response to determining the presence of the co-channel broadcast control channel interference, initiating a synchronization channel re-read based upon one or more co-channel interference criteria; wherein the synchronization channel re-read is adapted to determine if one or more neighbouring cells that are broadcasting on the same frequency as the broadcast control channel frequency of the current serving cell would be better than the current serving cell.

According to a second aspect of the present invention, there is provided apparatus including a processing system arranged to cause the apparatus to at least: periodically measure a received signal strength indication of a broadcast control channel received from a current serving cell to detect a presence of a co-channel broadcast control channel interference; and in response to determining the presence of the co-channel broadcast control channel interference, initiate a synchronization channel re-read based upon one or more co-channel interference criteria, wherein the synchronization channel re-read is adapted to determine if one or more neighbouring cells that are broadcasting on the same frequency as the broadcast control channel frequency of the current serving cell would be better than the current serving cell.

According to a third aspect of the present invention, there is provided a non-transitory computer-readable storage medium including a set of computer-readable instructions stored thereon, which when executed by a processor causes performance of operations, said operations including: periodically measuring a received signal strength indication of a broadcast control channel received from a current serving cell to detect a presence of a co-channel broadcast control channel interference; and in response to determining the presence of the co-channel broadcast control channel interference, initiating a synchronization channel re-read based upon one or more co-channel interference criteria; wherein the synchronization channel re-read is adapted to determine if one or more neighbouring cells that are broadcasting on the same frequency as the broadcast control channel frequency of the current serving cell would be better than the current serving cell.

According to a fourth aspect of the present invention, there is provided apparatus including: means for periodically measuring a received signal strength indication of a broadcast control channel received from a current serving cell to detect a presence of a co-channel broadcast control channel interfere; and means for, in response to determining the presence of the co-channel broadcast control channel interference, initiating a synchronization channel re-read based upon one or more co-channel interference criteria; wherein the synchronization channel re-read is adapted to determine if one or more neighbouring cells that are broadcasting on the same frequency as the broadcast control channel frequency of the current serving cell would be better than the current serving cell.

The processing system described above may include at least one processor and at least one memory which stores a computer program, the at least one memory with the computer program being configured with the at least one processor to cause the apparatus at least to operate as described above.

There may be provided a computer readable memory which stores a computer program as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1(a) shows schematically a wireless communication system suitable for carrying out some example embodiments of the presence invention;

FIG. 1(b) shows schematically a simplified block diagram of an example of a user equipment suitable for use in practising sonic example embodiments of the invention; and

FIG. 2 shows a schematic flow diagram of the operation of an example of a method, and a result of execution of computer program instructions embodied on a computer readable memory of a user equipment, in accordance with some exemplary embodiments of this invention.

### DETAILED DESCRIPTION

Some example embodiments of this invention provide apparatus, methods, and computer programs that periodically measuring a received signal strength indication of a broadcast control channel received from a current serving cell to detect a presence of a co-channel broadcast control channel interference. In response to determining the presence of the co-channel broadcast control channel interference, a synchronization channel re-read based upon one or more co-channel interference criteria is initiated. The synchronization channel re-read is adapted to determine if one or more neighbouring cells that are broadcasting on the same frequency as the broadcast control channel frequency of the current serving cell would be better than the current serving cell. The synchronization channel re-read is further adapted to operation in one or more operational modes.

Co-channel interference refers to the occurrence of interference on the frequency of interest when one or more independent signals are transmitted simultaneously on the same frequency band as the frequency of interest. Also, co-channel interference refers to the power level coming to the receiver within the band of interest due to a certain frequency reuse in neighbouring cells in the network (e.g. in accordance with a reuse pattern in GSM). The larger the number of frequencies used in the reuse pattern, the lower the network capacity. In response to increased demands for capacity, network deployment designs are now typically calling for, for example, a cell layout with frequency reuse factors of 7 and 3 which translates into a smaller cell size as less transmitted power is required. However, the down side of such cell layouts is that they are closely spaced so a higher frequency reuse factor means more co-channel interference among closely located cells.

The Third Generation Partnership Project (3GPP) has standardized various neighbouring cell monitoring rules and cell reselection criteria. See for example 3GPP Technical Specification (TS) GSM/EDGE Radio Access Network, Radio Subsystem link control (Release 11) 3GPP TS 45.008 V11.2.0 (2012-08). For example, in section 6.6 of the standard, a mobile station (MS) which is already registered and camped on a cell in idle mode initiates cell reselection to find the better cell in accordance with monitoring rules which involves synchronization to and reading the BCCH information for the six strongest non-serving carriers in a BCCH allocation (BA) table (e.g. BA(list) or BA(GPRS)). The BA table is primarily a list of frequencies of neighbouring cells. Additional information provided in a system information (SI) message can pair the list of frequencies with a Base Station Identification Code (BSIC). For example, a SI type 2 message is provided which is a mandatory SI message that contains information such as parameters related to the MS initial access to the network via an uplink channel (e.g. Random Access Channel (RACH)) and BCCH allocations of neighbouring cells. Additional optional SI type 2 messages are provided and include the SI type 2 ter message and/or SI type 2 quarter message. The SI type 2 ter message provides information on the extension of the BCCH allocation of the neighbouring cells while the SI type 2 quarter message provides information regarding additional measurement and reporting parameters. The SI 4 message is another mandatory SI message which provides information about the cell broadcast channel (CBCH) parameters in addition to the cell identity, the location area identification and cell selection parameters. SI type 16 and type 17 messages provide information about the cell selection and re-selection parameters, respectively.

The above referenced standard provides rules to make sure the MS is camped on the best cell. That is, the MS continuously monitors all BCCH carriers as indicated by the BCCH allocation (BA) table based upon a running average of received signal level (RLA_C) every 5 seconds. The RLA_C are unweighted averages of the received signal levels measured in dBm. During the course of the above described continuous monitoring by the MS (at least every 5 seconds), a new path loss criterion (C1) is calculated for the serving cell to determine if it has fallen below zero for a period of 5 seconds. If the C1 falls below zero for 5 seconds, a reselection criterion value (C2) is calculated by the MS for the serving and non-serving cells to determine if the current serving cell is the strongest cell among all of the cells. If the serving cell does not have the highest C2 value, the non-serving cell with the highest C2 is selected and the MS moves to that non-serving cell and camps on it (as well as continuing to monitor for the best cell as described above).

These rules set forth in 3GPP TS 45.008 are built on the assumption that signal strength measurements on one particular carrier reflect the quality of a single BCCH carrier in a cell that employs a low frequency re-use policy. Furthermore, the above rules assumed that the MS would discard measurements for a particular frequency if it became strongly interfered by another co-channel BCCH carrier and as a consequence would sooner or later detect another better cell on this specific frequency (once the signal to interference ratio of one BCCH becomes large enough).

Also, the above mentioned specification also provides rules for cell monitoring and specifies triggers for reselection in dedicated mode, including enhanced measurement reporting rules. Also provided for in the above referenced specification are exceptional cases such as where the MS is operating in a 2.5G network such as General Packet Radio Service (GPRS) employing Network_Control_Order (NC)1 (reselection autonomously controlled by the MS) or NC2 (network controls the cell reselection) mode. Another exceptional case provided by the standard is operations in dual transfer mode (DTM) (e.g. simultaneous transfer of circuit switched (CS) voice and packet switched (PS) data over the same radio channel).

However, the above referenced standard does not contemplate an enhanced GSM receiver which is applying its enhancement capabilities for improving its synchronization (SCH) performance (e.g. enhancements capabilities required for the GSM receiver to be Downlink Advance Receiver Performance (DARP) Phase I compliant, or DARP Phase II compliant, or TIGHTER compliant). The current standard is intended for a traditional mobile station with a traditional receiver which is only utilizing its capabilities to meet the 3GPP prescribed conformance requirements when needed. As such, employing the above standardized monitoring rules merely results in monitoring a frequency of interest for a decrease in path loss (e.g. employing RSSI on the BCCH) and reselecting a cell based upon those rules.

A MS or user equipment with an enhanced GSM receiver (applying its enhancement capabilities for improving its SCH performance) on the other hand is capable of decoding a SCH burst in scenarios where strong co-channel interference is present. The significance of this is that in certain scenarios the MS may stay on a serving cell and ignore a neighbouring cell with stronger power level which is transmitting on the same BCCH frequency as the serving cell. This is because the enhanced GSM receiver allows the MS or UE to decode the SCH in interference scenarios with a zero or negative carrier-to-co-channel interference ratio, according to existing rules. The observed and reported power level in this case may consist of the signal power from the current serving cell plus the signal power from one or more other BCCH carriers on the same frequency where the signal power from other carriers may eventually exceed the signal power from the current serving cell. Reported here means the RSSI that is reported to the network in case of network controlled mobility as well as the RSSI reported to “upper layers” for cell reselection evaluation. Since the MS is continuously able to decode the BSIC from the current serving cell, the MS is allowed to keep reporting the RSSI for the current serving cell even if another neighbouring cell (with a different SCH/BSIC) should be reported as best cell (e.g. that cell is stronger on that frequency). In summary, enhanced performance mobile stations or user equipment (e.g. those with DARP, Phase I, DARP, Phase I or TIGHTER compliant GSM receiver) tolerate extreme interference levels and will not disconnect service because of strong co-channel interference which otherwise would have forced the mobile station to start searching for a better cell.

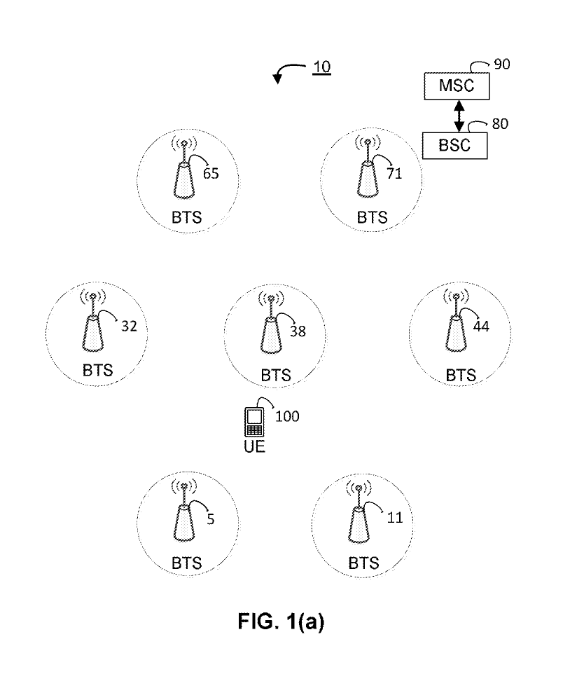

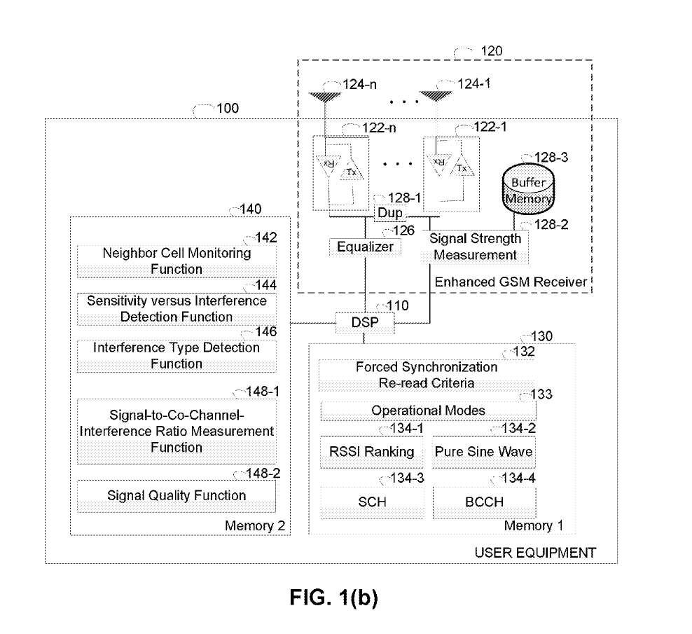

FIG. 1(a) shows schematically a wireless communications system 10 including a plurality of base transceiver stations (BTS) 5, 11, 32, 38, 44, 65, and 71 adapted for transmitting on the same frequency with user equipment (UE) 100 and is suitable for carrying out some example embodiments of the present invention. BTS 5, 11, 32, 38, 44, 65, and 71 as well as UE 100 are adapted for commutating on a GSM/Enhanced Data Rates for GSM Evolution (EDGE) Radio Access Network (GERAN). Moreover, UE 100 is a wireless communication device such as a mobile station (MS) adapted for solely communicating on a GSM/EDGE RAN or a user equipment adapted for communicating on multiple wireless communication systems not limited to Universal Terrestrial Radio Access Network (UTRAN), Evolved Universal Terrestrial Radio Access Network (EUTRAN) as described in Long Term Evolution/Long Term Evolution Advanced/Long Term Evolved-Advanced (LTE/LTE-A), a first responder network or other similar radio access networks.

Also shown in FIG. 1(a) is a base station controller (BSC) 80 and a Mobile switching centre (MSC) 90 is shown which is adapted for controlling multiple BTSs such as BTS 5, 11, 32, 38, 44, 65, and 71. BSC 80 together with MSC 90 perform tasks such as allocating radio channels, providing frequency administration, power and signal measurements from UE 100, and handovers (e.g. cell reselection) from one BTS to another.

Referring now to FIG. 1(b), a simplified block program of an example of a UE 100 is shown in accordance with some example embodiment of the present invention. UE includes an enhanced GSM receiver 120. In one example embodiment of the present invention, GSM receiver 120 is a downlink advance receiver performance (DARP) Phase I compliant GSM receiver. In an alternative embodiment, GSM receiver 120 is a downlink advance receiver performance (DARP) Phase II compliant GSM receiver. In yet another embodiment, GSM receiver 120 is a TIGHTER compliant GSM receiver.

GSM receiver 120 includes one or more transceiver units 122-1 and 122-n. Each transceiver unit is adapted for commutating on a GSM/EDGE radio access network in accordance with one or more embodiments of the present invention (e.g. DARP Phase I, DARP Phase II or TIGHTER type and the like). Each one or more transceiver units 122-1 and 122-n includes one or more antenna, such as antenna 124-1 coupled to transceiver unit 122-1 and antenna 124-n coupled to transceiver units 122-n. Such antennas may further attach exteriorly to UE 100 or be disposed inside the UE 100 or may be omitted as well known in the art. A general purpose equalizer 126 is shown and is suitable for adaptively equalizing all parts of received signals with respect to time delay and frequency to mitigate, among other things, mobile fading and inter symbol interference (ISI) as known in the art. A duplexer 281-1 is coupled both to the transceiver and receiver portions of the RF front end of 122-1 and 122-n adapted to (among other things) isolate a transmitted signal from the received signal in the received band (e.g. to avoid degrading the receiver sensitivity) and attenuate the receiver's spurious responses. A received signal strength measurement indicator 128-2 is provided for measuring the power levels in decibels (dBs) of frequency channels employed by the transceiver units 122-1 and 122-n. Each received frequency is stored in buffer memory 128-3 A signal quality function 148-2 is adapted to monitor the quality of the received broadcast channel by utilizing information obtained from the RSSI measurements (e.g. data stored in buffer memory 128-3) together with information from the signal-to-co-channel interference ratio measurement function 148-1 in accordance with some example embodiments of the present invention. For example, a strong RSSI measure together with a high signal-to-co-channel interference ratio indicates a good broadcast channel quality whereas a strong RSSI measure together with a low signal-to-co-channel interference ratio indicates a broadcast channel being co-channel interference limited. For both the utilization of the signal-to-co-channel interference ratios and the RSSI measures, various filtering techniques as known in the art can be applied to improve their accuracy (e.g. simple running averaging techniques). It should be noted that for clarity purposes, well known components known in the art in the RF front end and broadband unit commonly provided in a receiver such as GSM receiver 120 have been omitted to simplify this descriptions. GSM receiver 120 can be a radio frequency integrated component (RFIC), a discrete component/module or disposed in a system-in-package (SIP) or otherwise coupled or integrated into the mobile terminal or user equipment as known in the art.

As shown in FIG. 1(b), UE 100 includes one or more processors, such as at least one digital signal (DSP) 110, and at least a first computer-readable memory 130, which stores a plurality of parameters. For example, a first computer-readable memory 130 includes one or more synchronization re-read criteria 132 as described in more detail below with respect the method and computer program implementation of one or more embodiments of the present invention. Also included are parameters related to the one or more operational modes 133 which control the operation of the synchronization re-read in accordance with one or more example embodiments of the present invention. Additional parameters include a ranked list of frequency arranged according to received signal strength corresponding to the broadcast control channel (RSSI Ranking) 134-1. In one example embodiment the frequencies in RSSI Ranking 134-1 correspond to the frequencies of the six (6) strongest non-serving carriers in a BCCH allocation. (BA) table (e.g. BA(list) or BA(GPRS)) obtained in a system information (SI) message (e.g. NC_FREQUENCY_LIST).

Another parameter stored in first computer-readable memory 130 is the pure sine wave (PSW) 134-2. As well known in the art, in GSM/GPRS systems, frequency synchronization is achieved through the detection of the presence of a frequency correction burst (FB) wherein the frequency is estimated from the detected FB. The FB is used by the user equipment to detect a special carrier with is transmitted by every BTS in a GSM network. The baseband signal is sampled and then complex de-rotated. After that down-mixing, the FB will be a pure sine wave (PSW) 134-2 with a frequency of 67.7 kHz plus the frequency offset. That is, after a complex rotation, the FB is seen as a PSW 134-2 with a frequency equal to the frequency offset.

Yet another parameter stored in first computer-readable memory 130 is a Synchronization Channel (SCH) 134-3 which is a downlink (DL) only channel containing 25 bits primarily used for frame synchronization (e.g. TDMA frame number) and identification of the base station. SCH 134-3 information contains the network and BTS (cell) identification number, as well as all necessary information needed to synchronize within a BTS. The frame number (FN) which ranges from 0 to 2,715,647 is sent along with the base station identity code on the SCH burst. As such, using the information supplied in SCH 134-3, UE 100 can fully synchronize its frame counters with those of a BTS. SCH 134-3 includes, for example, a 6-bit base station identity code (BSIC) which consists of a 3-bit network colour code (NCC) and 3-bit BS colour code (BCC) assigned by a network operator during the network frequency planning. The term colour is used by those skilled in the art to refer to the assignment of these codes by colouring the regions on a map according to the code that is used within a particular deployment area as determined by network operators. Where two networks share the same frequency band, each is assigned a different NCC (e.g. their BCC may be the same but the NCC will be different). Accordingly, two networks cannot use the same BSIC.

Yet another parameter stored in first computer-readable memory 130 is a broadcast channel (BCCH) 134-4 which is a downlink only channel adapted to carry information regarding general cell specific information such as local area code (LAC) network operator, access parameters, list of neighbouring BTSs and so on to UE 100, BCCH 134-4 receives signals via the broadcast control channel (BCCH) from many BTSs within the same network and/or different networks. The TS0 of the broadcast frequency channel will contain BCCH channel data during its specific TDMA frames. It appears next to the SCH channel TDMA frame number (only for the first time) in a group of four consecutive frames in the control frame multi-frame structure. BCCH 134-4 as described in more detail below with respect to the method and computer executed operation of the present invention is only utilized for reselection to another cell (e.g. initiated based on BSIC detection).

Also, as shown in FIG. 1(b), a second computer-readable memory 140 stores one or more one or more co-channel interference criterion functions in accordance with one or more example embodiments of the presence invention. For example, one criterion function includes a neighbour cell monitoring function 142 which detects if a “strong” received signal strength indication is measured on an actual time division multiple access slot with the current serving cell. In this example embodiment, DSP 110 periodically queries buffer memory 128-3 to determine the received signal strength measurement 128-2 of the received broadcast channel (BCCH). That data represents the power level of the frequency employed by UE 100 camped on a BTS (e.g. BCCH). The data obtained from buffer memory 128-1 can for example be compared to the information in RSSI Ranking 134-1. In other words, a comparison is made between the power level of the frequency currently in use between UE 100 and BTS it is camped on and those frequencies originating from neighbouring cells (e.g. the current carrier is located among the top ranked carriers).

Although FIG. 1(b) depicts a first computer-readable memory 130 and a second computer-readable memory 140, UE 100 may include one or more additional memories or fewer memory units for carrying out some example embodiments of the present invention. Moreover, the functions described above (e.g. neighbour cell monitoring function 142, sensitivity versus interference detection function 144, interference type detection function 146, signal-to-co-channel-interference ratio measurement function 148-1 and signal quality function 148-2) are not limited to specific memory locations (e.g. a first computer-readable memory 130 and a second computer-readable memory 140). Similarly, parameters (e,g. RSSI ranking 134-1, PSW 134-2 SCH 134-3, and BCCH 134-4), criteria (e.g. forced synchronization re-read criteria 132) and modes (e.g. operational modes 133) are not limited to specific memory locations (e.g. a first computer-readable memory 130 and a second computer-readable memory 140). FIG. 1(b) merely shows one possible non-limiting example embodiment of the present invention.

Another co-channel interference criterion function stored in second computer-readable memory 140 is sensitivity versus interference detection function 144. In one example embodiment, a detector (e.g. classifier) is employed for determining the physical radio environment UE 100 which is adapted to operate in interference limited radio conditions versus sensitivity limited radio conditions. For example, a DARP phase I compliant GSM receiver can be adapted to utilize various techniques to enhance its performance when operating in interference limited scenarios and allocated to Gaussian minimum shift keying (GMSK) modulation services. As known in the art, GMSK modulation has I and Q channels and carries the same information in both channels. As such, two separate channels carry the same information and experience channel impairment independently. Accordingly, sensitivity versus interference detection function 144 switches between 1) an optimized received (RX) processing branch for sensitivity limited data versus 2) an optimized RX processing branch for interference limited data.

Yet another co-channel interference criterion function stored in second computer-readable memory 140 is an interference type detection function 146. Such a function is adapted to detect and classify interference between adjacent channel interference (ACI) and co-channel interference (CCI). ACI is typically caused by signals from nearby frequency channels (e.g. adjacent channel) which leak into the desired channel. This type of interference can also be attributed to bad filtering, modulation and non-linearity within the electronic components. Yet another co-channel interference criterion function stored in second computer-readable memory 140 is a signal-to-co-channel interference ratio function 148-1. Such a function determines whether a co-channel to interference ratio exceeds a pre-specified threshold.

In one example embodiment, the carrier-to-interference (C/I) ratio estimated by UE 100 (e.g. in the interference cancellation branch) is verified against a pre-specified threshold set to for example less than zero decibels (<0 dB). In yet another example embodiment, the pre-specified threshold is −3 dB. In another example embodiment, the pre-specified is a range from for example −3 dB to −6 dB. In yet another example embodiment, the pre-specified threshold value is set by subtracting a positive numerical valued hysteresis parameter, e.g. x, from a 0 dB threshold value, meaning the co-channel to interference ratio threshold value is determined as (0−x) dB. Such a measurement indicates that the BCCH carrier experience a singe strong co-channel interferer with a power level stronger than the power level of the serving cell. Alternatively, such a measurement indicates that the BCCH carrier experiences two of more co-channel interferers which add up to a total co-channel interference power that is stronger than the power level of the serving cell.

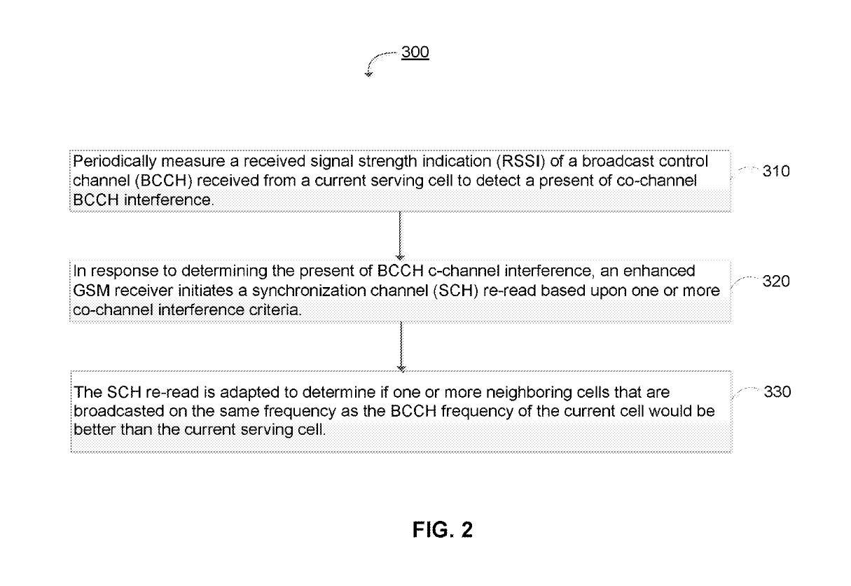

Referring now to FIG. 2, a flow diagram is provided to illustrate the operation of examples of a method, and a result of execution of computer program instructions tangibly embodied on a computer readable memory 400, suitable for carrying out some example embodiments of the presence invention. The methods, and computer programs, periodically measure a received signal strength indication of a broadcast control channel received from a current serving cell to detect a presence of co-channel broadcast control channel interference (310). In response to determining the presence of the co-channel broadcast control channel interference, a synchronization channel re-read is initiated based upon one or more co-channel interference criteria (320). The synchronization channel re-read is adapted to determine if one or more neighbouring cells that are broadcasting on the same frequency as the broadcast control channel frequency of the current serving cell would be better than the current serving cell (330).

In one example embodiment, the method or execution of computer program operations provides the step of filtering the measured signal strength indication of each broadcast control channel to improve a signal quality of the received signal strength indication.

In another example embodiment, the method or execution of computer program operations provides that the presence of co-channel interference is determined by a neighbour cell monitoring function, including comparing the received signal strength indication of the actual time division multiple access slot of the current serving cell with a power level of one or more frequencies associated with one or more broadcasting neighbouring cells to determine if the current serving cell is located among the top frequencies when ranked according to the measure of the received signal strength indication values.

In yet another example embodiment, the method or execution of computer program operations provides that the co-channel interference criteria include a sensitivity versus interference detection function adapted to classify and switch an I and Q output channel into an optimized received processing branch associated with sensitivity limited data and an optimized received processing branch associated with interference limited data.

In another example embodiment, the method or execution of computer program operations provides that the co-channel interference criteria is an interference type detection function adapted to detect and classify interference between adjacent channel interference and co-channel interference.

In yet another example embodiment, the method or execution of computer program operations provides that the co-channel interference criteria is a signal-to-co-channel interference ratio function continuously adapting an estimate of the signal-to-co-channel to interference ratio of the serving cell and verifies the estimate against a pre-specified threshold to determine whether the estimated signal-to-co-channel interference ratio exceeds the pre-specified threshold.

In yet another example embodiment, the method or execution of computer program operations provides that the pre-specified threshold is a carrier-to-co-channel interference ratio threshold which is less than zero decibels and the carrier-to-co-channel interference ratio is continuously measured by a user equipment, wherein the carrier-to-co-channel interference ratio threshold indicates that a broadcast control channel carrier experienced a single strong co-channel interferer with a power level stronger than the power level of the serving cell or indicates that the broadcast control channel carrier experiences two of more co-channel interferers which add up to a total co-channel interference power that is stronger than the power level of the serving cell.

In yet another example embodiment, the method or execution of computer program operations provides that wherein the broadcast control channel is received over an Evolved Universal Terrestrial. Radio Access Network, Universal Terrestrial Radio Access Network, Enhanced Data Rates for Global System for Mobile Communications Evolution Network public safety network or a first responder network.

In yet another embodiment the synchronization channel re-read is adapted to operate in one or more operational modes including: (i) a standard mode adapted to perform the synchronization channel re-read during a complete frequency control channel search/synchronization, search repetition period, wherein the synchronization channel re-read is selectively initiated at any uncontrolled point in time during the frequency control channel search or a subsequent synchronization search if a frequency burst is found with a different timing information from the current serving cell; (ii) a repetitive mode adapted to perform the synchronization channel re-read after the frequency burst of the current serving cell is detected and continuously searches until the frequency burst of the current serving cell is found again or another frequency control channel transmitted from another neighbouring cell is found; (iii) a modified repetitive mode adapted to perform the synchronization channel re-read continuously during the frequency control channel search until the strongest occurrence of a frequency control channel is found; and (iv) a controlled start time mode adapted to perform the synchronization channel re-read a scheduled start time after the detection of the frequency burst of the current serving cell.

Various embodiments of the computer readable memory such as those disclosed in FIG. 1(b) include any data storage technology type that is suitable to the local technical environment, including, but not limited to, semiconductor based memory devices, magnetic memory devices and systems, optical memory devices and systems, fixed memory, removable memory, disc memory, flash memory, DRAM, SRAM, EEPROM and the like. Various embodiments of the data processors include, but are not limited to, general purpose computers, special purpose computers, microprocessors, digital signal processors (DSPs) and multi-core processors.

As used in this specification, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) to circuits, such as a microprocessor(s) or a portion of a microprocessor(s), that require software or firmware for operation, even if the software or firmware is not physically presence. This definition of “circuitry” applies to all uses of this term in this specification, including in any claims. As a further example, as used in this specification, the term “circuitry” also covers an implementation of merely a processor (or multiple processors) or portion of a processor and its (or their) accompanying software and/or firmware. The term “circuitry” also covers, for example, and if applicable to the particular claim element, a baseband integrated circuit or applications specific integrated circuit for a mobile phone or a similar integrated circuit in a server, a cellular network device, or other network device. The reference throughout this disclosure to a UE may he embodied in a smart phone, a cellular phone, a personal digital assistant (PDA), a wireless modem, a wireless communication device, a laptop, a netbook, a tablet or any other device cable of communicating with an FirstNet, E-UTRAN, UTRAN or GERAN enabled device.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method comprising:
periodically measuring a received signal strength indication of a broadcast control channel received from a current serving cell to detect a presence of a co-channel broadcast control channel interference; and
in response to determining the presence of the co-channel broadcast control channel interference, initiating a synchronization channel re-read based upon one or more co-channel interference criteria;
wherein the synchronization channel re-read is adapted to determine if one or more neighbouring cells that are broadcasting on the same frequency as the broadcast control channel frequency of the current serving cell would be better than the current serving cell.

2. The method according to claim 1, wherein at least one of:
the method further comprising filtering the measured signal strength indication of each broadcast control channel to improve the accuracy of the received signal strength indication;
the presence of co-channel interference is determined by a neighbour cell monitoring function comprising comparing the received signal strength indication of an actual time division multiple access slot of the current serving cell with a power level of one or more frequencies associated with one or more broadcasting neighbouring cells to determine if the current serving cell is located among the top frequencies when ranked according to the measure of the received signal strength indication values;
the co-channel interference criteria comprise a sensitivity versus interference detection function, adapted to classify and switch an I and Q output channel into either an optimized received processing branch associated with sensitivity limited data or an optimized received processing branch associated with interference limited data;
the co-channel interference criteria comprise an interference type detection function adapted to detect and classify interference between adjacent channel interference and co-channel interference;
the co-channel interference criteria comprise a signal-to-co-channel interference ratio function continuously adapting an estimate of the signal-to-co-channel to interference ratio of the serving cell and verifies the estimate against a pre-specified threshold to determine whether the estimated signal-to-co-channel interference ratio exceeds the pre-specified threshold; and
the broadcast control channel is received, over an Evolved Universal Terrestrial Radio Access Network, Universal Terrestrial Radio Access Network, Enhanced Data Rates for Global System for Mobile Communications Evolution network public safety network or a first responder network.

3. The method according to claim 2, wherein the pre-specified threshold is a carrier-to-co-channel interference ratio threshold comprising at least one of:
a threshold value set less than zero decibels wherein the carrier-to-co-channel interference ratio is continuously measured by a user equipment;
a threshold value set to −3 decibels;
a threshold value a range from −3 decibels to −6 decibels; and
a threshold value a set by subtracting a positive numerical valued hysteresis parameter x from a 0 decibels threshold value;
wherein the carrier-to-co-channel interference ratio threshold indicates that a broadcast control channel carrier experienced a single strong co-channel interferer with a power level stronger than the power level of the serving cell or indicates that the broadcast control channel carrier experiences two of more co-channel interferers which add up to a total co-channel interference power that is stronger than the power level of the serving cell.

4. The method according to claim 1, wherein the synchronization channel re-read is adapted to operate in one or more operational modes comprising at least one of:
a standard mode adapted to perform the synchronization channel re-read during a complete frequency control channel search synchronization search repetition period, wherein the synchronization channel re-read is selectively initiated at any uncontrolled point in time during the frequency control channel search or a subsequent synchronization search if a frequency burst is found with a different timing information from the current serving cell;
a repetitive mode adapted to perform the synchronization channel re-read alter the frequency burst of the current serving cell is detected and continuously searches until the frequency burst of the current serving cell is found again or another frequency control channel transmitted from another neighbouring cell is found;
a modified repetitive mode adapted to perform the synchronization channel re-read continuously during the frequency control channel search until the strongest occurrence of a frequency control channel is found; and
a controlled start time mode adapted to perform the synchronization channel re-read a scheduled start time after the detection of the frequency burst of the current serving cell.

5. An apparatus comprising a processing system arranged to cause the apparatus to at least:
periodically measure a received signal strength indication of a broadcast control channel received from a current serving cell to detect a presence of a co-channel broadcast control channel interference; and
in response to determining the presence of the co-channel broadcast control channel interference, initiate a synchronization channel re-read based upon one or more co-channel interference criteria;
wherein the synchronization channel re-read is adapted to determine if one or more neighbouring cells that are broadcasting on the same frequency as the broadcast control channel frequency of the current serving cell would be better than the current serving cell.

6. The apparatus according to claim 5, wherein at least one of:
the apparatus further comprises a signal quality function adapted for filtering the measured signal strength indication of each broadcast control channel to improve the accuracy of the received signal strength indication;
the presence of co-channel interference is determined by a neighbour cell monitoring function, the apparatus being arranged to compare the received signal strength indication of the actual time division multiple access slot of the current serving cell with a power level of one or more frequencies associated with one or more broadcasting neighbouring cells to determine if the current serving cell is located among the top frequencies when ranked according to the measure of the received signal strength indication values;
the co-channel interference criteria comprise a sensitivity versus interference detection function adapted to classify and switch an I and Q output channel into either an optimized received processing branch associated with sensitivity limited data or an optimized received processing branch associated with interference limited data;
the co-channel interference criteria comprise an interference type detection function adapted to detect and classify interference between adjacent channel interference and co-channel interference; and
the co-channel interference criteria comprise a signal-to-co-channel interference ratio function continuously adapting an estimate of the signal-to-co-channel to interference ratio of the serving cell and verifies the estimate against a pre-specified threshold to determine whether the estimated signal-to-co-channel interference ratio exceeds the pre-specified threshold.

7. The apparatus according to claim 6, wherein the pre-specified threshold is a carrier-to-co-channel interference ratio threshold comprising at least one of a threshold value set less than zero decibels wherein the carrier-to-co-channel interference ratio is continuously measured by a user equipment;
a threshold value set to −3 decibels;
a threshold value a range from −3 decibels to −6 decibels; and
a threshold value a set by subtracting a positive numerical valued hysteresis parameter x from a 0 decibels threshold value;
wherein the carrier-to-co-channel interference ratio threshold indicates that a broadcast control channel carrier experienced a single strong co-channel interferer with a power level stronger than the power level of the serving cell or indicates that the broadcast control channel carrier experiences two of more co-channel interferers which add up to a total co-channel interference power that is stronger than the power level of the serving cell.

8. The apparatus according to claim 5, wherein at least one of:
the apparatus is a downlink advance receiver performance phase I, or downlink advance receiver performance phase II, or TIGHTER compliant Global System for Mobile Communications receiver;
the apparatus is coupled to a mobile station or user equipment; and
wherein the mobile station or user equipment is adaptively configured to utilize various enhancement processing techniques to enhance its synchronization performance when operating in interference limited scenarios.

9. The apparatus according to claim 8, wherein at least one of:
the various enhancement processing techniques are based on the techniques required for facilitating a mobile station or user equipment to be either the downlink advance receiver performance phase I, or the downlink advance receiver performance phase II, or the tightened link level performance requirements for single antenna mobile station compliant TIGHTER Global System for Mobile Communications receiver;
the mobile station or user equipment is a smart phone, a cellular phone, a personal digital assistant, a wireless modem, a wireless communication device, a laptop, a netbook, a tablet or any other device cable of communicating with an FirstNet, Evolved Universal Terrestrial Radio Access Network, Universal Terrestrial Radio Access Network, Global System for Mobile Communications, or Enhanced Data Rates for Global System for Mobile Communications Evolution enabled device; and
the broadcast control channel is received over an Evolved Universal Terrestrial Radio Access Network, Universal Terrestrial Radio Access Network, Enhanced Data Rates for Global System for Mobile Communications Evolution network public safety network or a first responder network.

10. The apparatus according to claim 5, wherein the synchronization channel re-read is adapted to operate in one or more operational modes comprising at least one of:
a standard mode adapted to perform the synchronization channel re-read during a complete frequency control channel search synchronization search repetition period, wherein the synchronization channel re-read is selectively initiated at any uncontrolled point in time during the frequency control channel search or a subsequent synchronization search if a frequency burst is found with a different timing information from the current serving cell;
a repetitive mode adapted to perform the synchronization channel re-read after the frequency burst of the current serving cell is detected and continuously searches until the frequency burst of the current serving cell is found again or another frequency control channel transmitted from another neighbouring cell is found;
a modified repetitive mode adapted to perform the synchronization channel re-read continuously during the frequency control channel search until the strongest occurrence of a frequency control channel is found; and
a controlled start time mode adapted to perform the synchronization channel re-read a scheduled start time after the detection of the frequency burst of the current serving cell.

11. A non-transitory computer-readable storage medium comprising a set of computer-readable instructions stored thereon, which, when executed by a processor, causes the processor to:
periodically measure a received signal strength indication of a broadcast control channel received from a current serving cell to detect a presence of a co-channel broadcast control channel interference; and
in response to determining the presence of the co-channel broadcast control channel interference, initiate a synchronization channel re-read based upon one or more co-channel interference criteria;
wherein the synchronization channel re-read is adapted to determine if one or more neighbouring cells that are broadcasting on the same frequency as the broadcast control channel frequency of the current serving cell would be better than the current serving cell.

12. The non-transitory computer-readable storage medium according to claim 11, wherein at least one of:
the method further comprising instructions for filtering the measured signal strength indication of each broadcast control channel to improve the accuracy of the received signal strength indication;
the presence of co-channel interference is determined by a neighbour cell monitoring function comprising comparing the received signal strength indication of an actual time division multiple access slot of the current serving cell with a power level of one or more frequencies associated with one or more broadcasting neighbouring cells to determine if the current serving cell is located among the top frequencies when ranked according to the measure of the received signal strength indication values;
the co-channel interference criteria comprise a sensitivity versus interference detection function adapted to classify and switch an I and Q output channel into either an optimized received processing branch associated with sensitivity limited data or an optimized received processing branch associated with interference limited data;
the co-channel interference criteria is an interference type detection function adapted to detect and classify interference between adjacent channel interference and co-channel interference; and
the co-channel interference criteria comprise a signal-to-co-channel interference ratio function continuously adapting an estimate of the signal-to-co-channel to interference ratio of the serving cell and verifies the estimate against a pre-specified threshold to determine whether the estimated signal-to-co-channel interference ratio exceeds the pre-specified threshold.

13. The non-transitory computer-readable storage medium according to claim 12, wherein the pre-specified threshold is a carrier-to-co-channel interference ratio threshold comprising at least one of:
a threshold value set less than zero decibels wherein the earlier-to-co-channel interference ratio is continuously measured by a user equipment;
a threshold value set to −3 decibels;
a threshold value a range from −3 decibels to −6 decibels; and
a threshold value a set by subtracting a positive numerical valued hysteresis parameter x from a 0 decibels threshold value;
wherein the carrier-to-co-channel interference ratio threshold indicates that a broadcast control channel carrier experienced a single strong co-channel interferer with a power level stronger than the power level of the serving cell or indicates that the broadcast control channel carrier experiences two of more co-channel interferers which add up to a total co-channel interference power that is stronger than the power level of the serving cell.

14. The non-transitory computer-readable storage medium according to claim 11, wherein the broadcast control channel is received over an Evolved Universal Terrestrial Radio Access Network, Universal Terrestrial Radio Access Network, Enhanced Data Rates for Global System for Mobile Communication Evolution network public safety network or a first responder network.

15. The non-transitory computer-readable storage medium according to claim 11, wherein the synchronization channel re-read is adapted to operate in one or more operational modes comprising at least one of:
a standard mode adapted to perform the synchronization channel re-read during a complete frequency control channel search/synchronization search repetition period, wherein the synchronization channel re-read is selectively initiated at any uncontrolled point in time during the frequency control channel search or a subsequent synchronization search if a frequency burst is found with a different timing information from the current serving cell;
a repetitive mode adapted to perform the synchronization channel re-read after the frequency burst of the current serving cell is detected and continuously searches until the frequency burst of the current serving cell is found again or another frequency control channel transmitted from another neighbouring cell is found;
a modified repetitive mode adapted to perform the synchronization channel re-read continuously during the frequency control channel search until the strongest occurrence of a frequency control channel is found; and
a controlled start time mode adapted to perform the synchronization channel re-read a scheduled start time after the detection of the frequency burst of the current serving cell.
